(19) United States
(12) Patent Application Publication
(10) Pub. No.: US 2007/0204345 A1
(43) Pub. Date: Aug. 30, 2007

(54) Method of detecting computer security threats

(76) Inventors: Elton Pereira, Victoria (CA); Adrian Pereira, Victoria (CA); Donald Wharton, Victoria (CA); Christopher Coldwell, Victoria (CA); Michael Conn, Victoria (CA)

Correspondence Address: DAVIS & BUJOLD, P.L.L.C., 112 PLEASANT STREET, CONCORD, NH, 03301, US

(21) Appl. No.: 11/364,098

(22) Filed: Feb. 28, 2006

(51) Int. Cl. G06F 12/14

(52) U.S. Cl. 726/24

(57) ABSTRACT

A method of detecting computer security threats. A first step involves providing a reference database of selected parameters to be monitored relating to one of human behaviour when operating a computer or software behaviour during operation of a computer. A second step involves monitoring one of human behaviour or software behaviour originating from a selected computer over a time interval. A third step involves comparing the monitored behaviours to the selected parameters in the reference database and determining the presence or absence of a potential security threat from such comparison.

### FIELD OF THE INVENTION

The present invention relates to a method of detecting computer security threats, such as viruses, spy ware, hacking, or unauthorized use.

### BACKGROUND OF THE INVENTION

There are currently a number of commercially available “anti-virus” programs which detect viruses or spy ware by looking for code in software, which matches one of many “virus definitions” in a reference database. The “virus definitions” are frequently updated as new viruses are discovered and their code is added to the reference database.

### SUMMARY OF THE INVENTION

According to the present invention there is provided a method of detecting computer security threats. A first step involves providing a reference database of selected parameters to be monitored relating to one of human behaviour when operating a computer or software behaviour during operation of a computer. A second step involves monitoring one of human behaviour or software behaviour originating from a selected computer over a time interval. A third step involves comparing the monitored behaviours to the selected parameters in the reference database and determining the presence or absence of a potential security threat from such comparison.

The present method of focusing upon behaviours is believed to be more effective in detecting new security threats than focusing on content, as behaviours indicative of a threat can be readily identified without knowing about the actual source of such behaviour.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram showing one possible relationship between system components in accordance with the method of detecting computer security threats using a reference database of negative behaviours.

FIG. 2 is a flow diagram setting forth a sequence of steps in collecting and analyzing data in accordance with the method of detecting computer security threats set forth in FIG. 1.

FIG. 3 is a block diagram showing one possible relationship between system components in accordance with the method of detecting computer security threats using a reference database of positive behaviours.

FIG. 4 is a flow diagram setting forth a sequence of steps in collecting and analyzing data in accordance with the method of detecting computer security threats set forth in FIG. 3.

### DETAILED DESCRIPTION OF THE PREFERRED EMBODIMENT

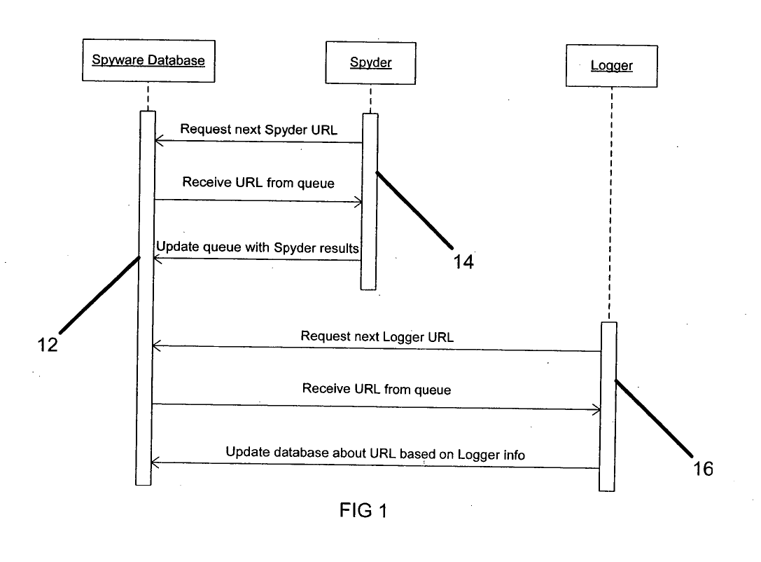

The preferred method of detecting computer security threats will now be described with reference to FIG. 1 through FIG. 4.

In broad terms, the present method can be broken down into three steps. A first step involves providing a reference database of selected parameters to be monitored relating to one of human behaviour when operating a computer or software behaviour during operation of a computer. A second step involves monitoring one of human behaviour or software behaviour originating from a selected computer over a time interval. A third step involves comparing the monitored behaviours to the selected parameters in the reference database and determining the presence or absence of a potential security threat from such comparison.

The examples which follow will show that the comparison may involve looking at software behaviour during operation of the computer or may involve looking for human behaviour during human use of the computer.

### FIRST EXAMPLE—MONITORING FOR SOFTWARE BEHAVIOUR

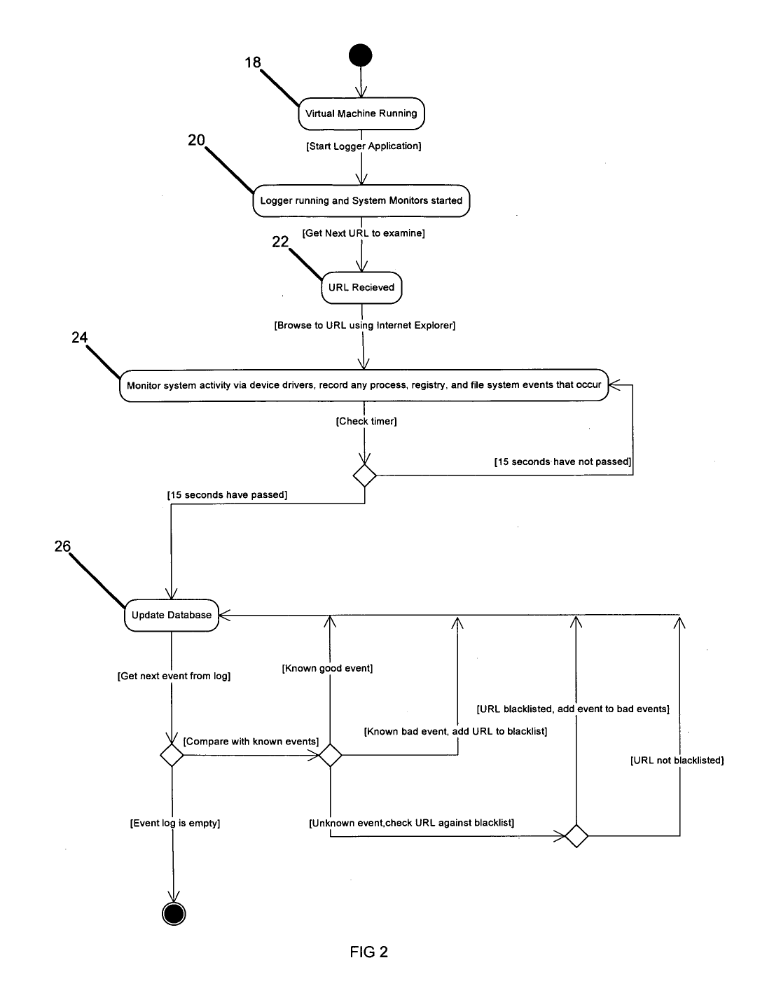

Referring to FIG. 1, there is illustrated a controller 12 which contains a reference database of selected parameters of software behaviour tending to indicate a likelihood that viruses or spy ware are present in the software. The software behaviour may include changing host computer settings, using host computer resources and programs, launching hidden processes that slow down the host computer, or gathering and making use of private information acquired from host computer. This list is not intended to be exhaustive. Indeed the selected parameters of software behaviour will be modified from time to time as the characteristic software behaviour of some of the threats evolve. The task assigned to controller 12 in this example is to evaluate which websites are “safe” websites and which websites constitute a threat and, as such, should be “blacklisted”. Controller 12 has a queue of URL addresses of websites to be evaluated. The tools used for the evaluation are Spyder 14 and logger 16. Spyder 14 seeks out the URL address assigned from controller 12 and visits the website. Logger 16 is then instructed to start monitoring behaviours originating from the monitored website over a time interval. As there are a large number of websites to be monitored, the time period should be as short as possible. It has been found that a time period as short as fifteen seconds is enough to obtain the necessary information. Of course, a longer time interval could be used. Logger 16 provides the logged information to Controller 12. Referring to FIG. 2, the logging process is set forth in a flow diagram. As shown in Block 18, signals to logger are initiated. As shown in Block 20, the logger starts running and system monitors are started. As shown in Block 22, the logger receives its URL monitoring assignment from the controller. As shown in Block 24, logging of behaviours continues for a fifteen second time interval. As shown in Block 26, this data log is transferred from the logger to the controller, where the Controller begins comparing the monitored behaviours to behaviours in the reference database and determining the presence or absence of a potential security threat posed by the website from such comparison. If a known negative behaviour is noted in the data log the URL is added to a “blacklist” of websites considered hostile. As stated above, the negative behaviours may include one or more of changing host computer settings, using host computer resources and programs, launching hidden processes that slow down the host computer, or gathering and making use of private information acquired from host computer. The reference database in Controller 12 may also contain a list of known positive behaviours. If a behaviour is not categorized as a positive behaviour or a negative behaviour, it is considered an “unknown” behaviour and is noted as such. If the URL is on the “blacklist”, such unknown behaviours are considered to be a further indication of a potential threat. If the URL is not on the “blacklist” the unknown event is not characterized as being either good or bad.

### SECOND EXAMPLE—MONITORING HUMAN BEHAVIOUR DURING COMPUTER OPERATION

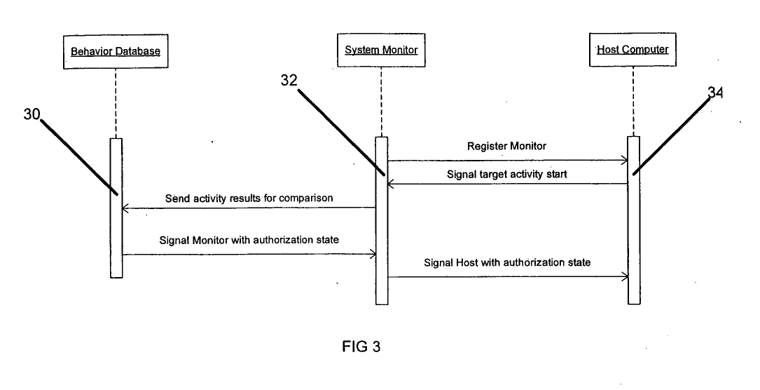

Referring to FIG. 3, there is illustrated the same method, only with a focus on human behaviour instead of software behaviour. A reference database 30 is provided of selected parameters to be monitored relating to human behaviour when operating a computer. The selected parameters are those tending to indicate a likelihood of computer use by an unauthorized user. The selected parameters relating to human behaviour may include file system usage, frequency of toggling between programs, patterns of computer access time, patterns of launching existing programs, and behaviours associated with compliance or breach of pre-determined security policy. It will be understood that this list is not exhaustive and has been selected for illustration purposes. A system monitor 32 is used to monitor human behaviour originating from a selected computer 34 over a time interval. System monitor 32 receives data relating to human behaviour during use of computer 34. The monitored human behaviour is compared to the selected parameters in reference database 30. System monitor 32 then determines the presence or absence of a potential security threat posed by an unauthorized user from such comparison.

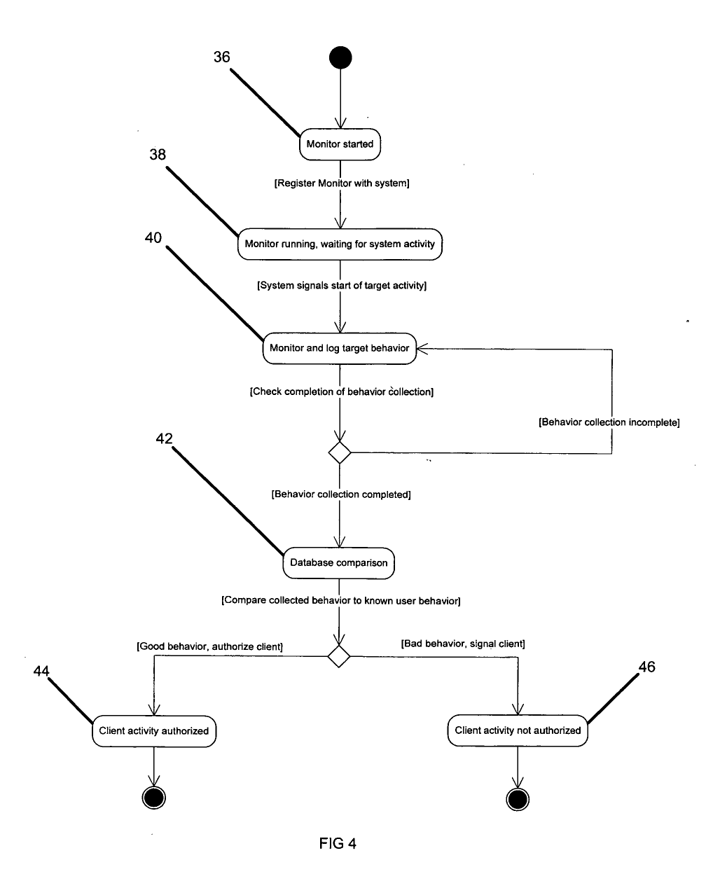

Referring to FIG. 4, the monitoring process is set forth in a flow diagram. As shown in Block 36, signals to system monitor 32 are initiated. As shown in Block 38, system monitor 32 starts system monitoring. As shown in Block 40, system monitor 32 logs human behaviour arising out of use of computer 34 for a time interval. As set forth above such human behaviour may include: file system usage, frequency of toggling between programs, patterns of computer access time, patterns of launching existing programs, and behaviours associated with compliance or breach of pre-determined security policy. As shown in Block 42, systems monitor 32 compares the monitored human behaviour to the selected parameters in the reference database. As shown in Block 44, if the human behaviour is identified as “good” behaviour and is consistent with the human behaviour during of operation the computer by the authorized user, the activity is allowed to continue as being “authorized”. As shown in Block 46, if the human behaviour is identified as “bad” behaviour or is inconsistent with the human behaviour during operation of the computer by the authorized user, the activity is terminated as being unauthorized and a potential security threat.

Advantages:

The method, as described above, is extremely adaptable. It merely looks for positive behaviours or negative behaviours listed within the selected parameters. The selected parameters may mimic the positive behaviours or the negative behaviours or may set forth a set of rules to be monitored for breach or compliance.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method of detecting computer security threats, comprising the steps of:
providing a reference database of selected parameters to be monitored relating to one of human behaviour when operating a computer or software behaviour during operation of a computer;
monitoring one of human behaviour or software behaviour originating from a selected computer over a time interval; and
comparing the monitored behaviours to the selected parameters in the reference database and determining the presence or absence of a potential security threat from such comparison.

2. The method as defined in claim 1, the selected computer operating a website.

3. The method as defined in claim 1, the selected parameters of the reference database containing software behaviour associated with viruses or spy ware.

4. The method as defined in claim 3, the software behaviour associated with viruses or spy ware including at least one of: changing host computer settings, using host computer resources and programs, launching hidden processes that slow down the host computer, or gathering and making use of private information acquired from host computer.

5. The method as defined in claim 1, the selected parameters of the reference database containing human behaviour associated with normal usage by an authorized user.

6. The method as defined in claim 5, the human behaviours associated with normal usage by an authorized user including at least one of: file system usage, frequency of toggling between programs, patterns of computer access time, patterns of launching existing programs, and behaviours associated with compliance with pre-determined security policy.

7. A method of detecting computer security threats, comprising the steps of:
providing a reference database of selected parameters to be monitored relating to software behaviour during operation of a computer, the selected parameters tending to indicate a likelihood that viruses or spy ware are present in the software;
monitoring software behaviour originating from a selected computer over a time interval; and
comparing the monitored software behaviour to the selected parameters in the reference database and determining the presence or absence of a potential security threat posed by the software behaviour from such comparison.

8. The method as defined in claim 7, the selected parameters of software behaviour in the reference database including at least one of: changing host computer settings, using host computer resources and programs, launching hidden processes that slow down the host computer, or gathering and making use of private information acquired from host computer;

9. A method of detecting computer security threats, comprising the steps of:
providing a reference database of selected parameters to be monitored relating to human behaviour when operating a computer, the selected parameters tending to indicate a likelihood of computer use by an unauthorized user;
monitoring human behaviour originating from a selected computer over a time interval; and
comparing the monitored human behaviour to the selected parameters in the reference database and determining the presence or absence of a potential security threat posed by an unauthorized user from such comparison.

10. The method as defined in claim 9, the selected parameters relating to human behaviour including at least one of: file system usage, frequency of toggling between programs, patterns of computer access time, patterns of launching existing programs, and behaviours associated with compliance or breach of pre-determined security policy.
